(19) United States
(12) Patent Application Publication
(10) Pub. No.: US 2019/0081864 A1
(43) Pub. Date: Mar. 14, 2019

(54) GATEWAY AND METHOD OF DETERMINING MACHINES TO BE NETWORKED AT GATEWAY

(71) Applicant: Institute For Information Industry, Taipei (TW)

(72) Inventors: Ping-Heng LI, Taipei City (TW); Tzu-Che HUANG, Taipei City (TW); I-An CHEN, Taipei City (TW); Tsung-Yi LEE, New Taipei City (TW)

(21) Appl. No.: 15/788,197

(22) Filed: Oct. 19, 2017

(30) Foreign Application Priority Data
Sep. 13, 2017 (TW) 106131423

(51) Int. Cl. H04L 12/24; H04L 29/08; H04L 12/66; H04L 29/06

(52) U.S. Cl. CPC H04L 41/22; H04L 67/12; H04L 69/18; H04L 41/0803; H04L 12/66

(57) ABSTRACT

Embodiments relate to a gateway and a method of determining machines to be networked at a gateway. In the embodiments, the gateway stores original channel information of a programmable logic controller (PLC) configured on an original networked machine. The gateway further defines a controlling logic process based on the original channel information, and selects at least one functional channel from a plurality of original channels of the PLC configured on the original networked machine. When a target networked machine connects to the gateway, the gateway determines whether the target networked machine is capable of replacing the original networked machine by comparing target channel information of a PLC configured on the target networked machine with channel information of the at least one functional channel.

### PRIORITY

This application claims priority to Taiwan Patent Application No. 106131423 filed on Sep. 13, 2017, which is hereby incorporated by reference in its entirety.

### FIELD

Embodiments of the present invention relate to a gateway and a method of determining machines to be networked at a gateway. More particularly, embodiments of the present invention relate to a gateway and a method of determining machines to be networked at a gateway which are applicable to Industrial Internet of Things (IIOT).

### BACKGROUND

IIOT is an important technique for accomplishing intelligent manufacturing. The architecture of the IIOT generally comprises three levels, i.e., a server level, a gateway level and a networked machine level. The networked machine level is configured to provide data from industrial machines capable of networking (called networked machines for short) to the server level, and the server level is configured to collect data from the networked machine level and manage and control the operation of the IIOT according to the collected data. The gateway level, as an interface/bridge between the server level and the networked machine level, is configured to transmit data from the networked machine level to the server level and control the networked machines in the networked machine level.

Each of the networked machines in the networked machine level may have a programmable logic controller (PLC) for connection with the gateway level. For any networked machine in the networked machine level, the gateway level may obtain data of the networked machine from a plurality of channels of the PLC configured on the networked machine, and may also manage and control the networked machine through the channels. However, the PLCs of different types of networked machines typically have different types of channels for providing different data. Additionally, even for the same types of networked machines, the PLCs thereof may also have different types of channels due to factors such as different manufactures, different models or different communication protocols so that same types of data cannot be provided. Therefore, once a target networked machine for replacing a certain original networked machine is added into the networked machine level, the conventional gateway level will compare channel information of all channels of the PLC configured on the target networked machine with channel information of all channels of the PLC configured on an original networked machine one by one and determine whether the target networked machine is capable of replacing the original networked machine according to the comparison result, in order to ensure that the server level, the gateway level and the networked machine level in the IIOT can maintain the previous normal operation. Obviously, such a determining mechanism is inefficient.

Accordingly, it is necessary in the art to provide a more efficient determining mechanism for determining whether the target networked machine is capable of replacing the original networked machine while ensuring that the server level, the gateway level and the networked machine level in the IIOT can maintain the previous normal operation.

### SUMMARY

The disclosure includes a gateway, and the gateway may comprise a first connection interface, a storage, and a processor connected to the first connection interface and the storage. The storage may be configured to store original channel information of a programmable logic controller (PLC) configured on an original networked machine. The processor may be configured to define a controlling logic process based on the original channel information of the original networked machine, and select at least one functional channel from a plurality of original channels of the PLC configured on the original networked machine according to the controlling logic process. When a target networked machine connects to the first connection interface, the processor may determine whether the target networked machine is capable of replacing the original networked machine by comparing target channel information of a PLC configured on the target networked machine with channel information of the at least one functional channel.

The disclosure also includes a method of determining machines to be networked at a gateway, and the method may comprise the following steps of:

defining, by the gateway, a controlling logic process based on original channel information of a PLC configured on an original networked machine;

selecting, by the gateway, at least one functional channel from a plurality of original channels of the PLC configured on the original networked machine according to the controlling logic process; and

determining, by the gateway when a target networked machine connects to the gateway, whether the target networked machine is capable of replacing the original networked machine by comparing target channel information of a PLC configured on the target networked machine with channel information of the at least one functional channel.

In certain embodiments, when a gateway connects to one or more original networked machines, the gateway may define a controlling logic process based on the original channel information of the one or more original networked machines, and select at least one functional channel (i.e., one or more functional channels) from a plurality of original channels of the PLC configured on the original networked machine or select at least one functional channel from a plurality of original channels of a plurality of PLCs configured on the original networked machines according to the controlling logic process. The gateway may control the one or more original networked machines according to the controlling logic process. The controlling logic process may comprise one or more control logics, and each of the control logics is at least associated with one channel of the PLC of one of the one or more original networked machines. When a target networked machine for replacing one of the one or more original networked machines connects to the gateway, the gateway may determine whether the target networked machine is capable of replacing the original networked machine by comparing target channel information of a PLC configured on the target networked machine with channel information of the at least one functional channel.

When comparing the target channel information of the PLC configured on the target networked machine with the channel information of the at least one functional channel, it can be ensured that the controlling logic process previously defined by the gateway will not be changed by replacing one of the one or more original networked machines with the target networked machine as long as the PLC on the target networked machine has a target channel of the same type as the at least one functional channel (i.e., a channel capable of providing the same type of data, or a channel having the same control function). To put it another way, in this case, the server level, the gateway level and the networked machine level can still maintain the previous normal operation without influencing the operation and the setting of other original networked machines after one of the one or more original networked machines is replaced by the target networked machine. Therefore, the gateway in the embodiments of the present invention can determine whether the target networked machine is capable of replacing one of the one or more original networked machines simply by comparing the target channel information of the PLC configured on the target networked machine with the channel information of the at least one functional channel, while ensuring that the server level, the gateway level and the networked machine level can maintain the previous normal operation. In other words, the gateway in the embodiment of the present invention does not need to compare information of all channels of the PLC configured on a target networked machine with information of all channels of the PLC configured on an original networked machine one by one in order to determine whether the target networked machine is capable of replacing the original networked machine, thereby improving the efficiency.

On the other hand, after replacing the original networked machine with the target networked machine, the gateway in the embodiment of the present invention does not need to re-define a controlling logic process to maintain the operation of the server level, the gateway level and the networked machine level, so the gateway is more efficient as compared to the conventional gateway. This benefit is more obvious particularly in a case where the previously defined controlling logic process covers a plurality of PLCs configured on a plurality of original networked machines and the plurality of original networked machines have different communication protocols.

According to the above descriptions, a more efficient determining mechanism for determining whether the target networked machine is capable of replacing the original networked machine is provided by the embodiments of the present invention, while ensuring that the server level, the gateway level and the networked machine level in the IIOT can maintain the previous normal operation.

This summary overall describes the core concept of the present invention and covers the problem to be solved, the means to solve the problem and the effect of the present invention to provide a basic understanding of the invention by a person having ordinary skill in the art. However, it shall be appreciated that, this summary is not intended to encompass all embodiments of the present invention but is provided only to present the core concept of the invention in a simple form and as an introduction to the following detailed description.

### BRIEF DESCRIPTION OF THE DRAWINGS

FIG. 1 illustrates an architecture of a gateway connected with one or more original networked machines, in one or more embodiments of the present invention.

FIG. 2 illustrates the gateway shown in FIG. 1 that is connected with a target networked machine for replacing an original networked machine.

FIG. 3A illustrates how a gateway determines whether a target networked machine is capable of replacing an original networked machine in one or more embodiments of the present invention, where a controlling logic process is defined by the gateway only associated with a single original networked machine;

FIG. 3B illustrates how a gateway determines whether a target networked machine is capable of replacing an original networked machine in one or more embodiments of the present invention, where a controlling logic process is defined by the gateway associated with a plurality of original networked machines; and

FIG. 4 illustrates a method of determining machines to be networked at a gateway in one or more embodiments of the present invention.

### DETAILED DESCRIPTION

The example embodiments of the present invention described below are not intended to limit the present invention to any specific embodiment, example, environment, applications, structures, processes or steps described in these example embodiments. In the attached drawings, elements unrelated to the present invention are omitted from depiction; and dimensions of elements and proportional relationships among individual elements in the attached drawings are only exemplary examples but not intended to limit the present invention. Unless stated particularly, same (or similar) element symbols may correspond to same (or similar) elements in the following description.

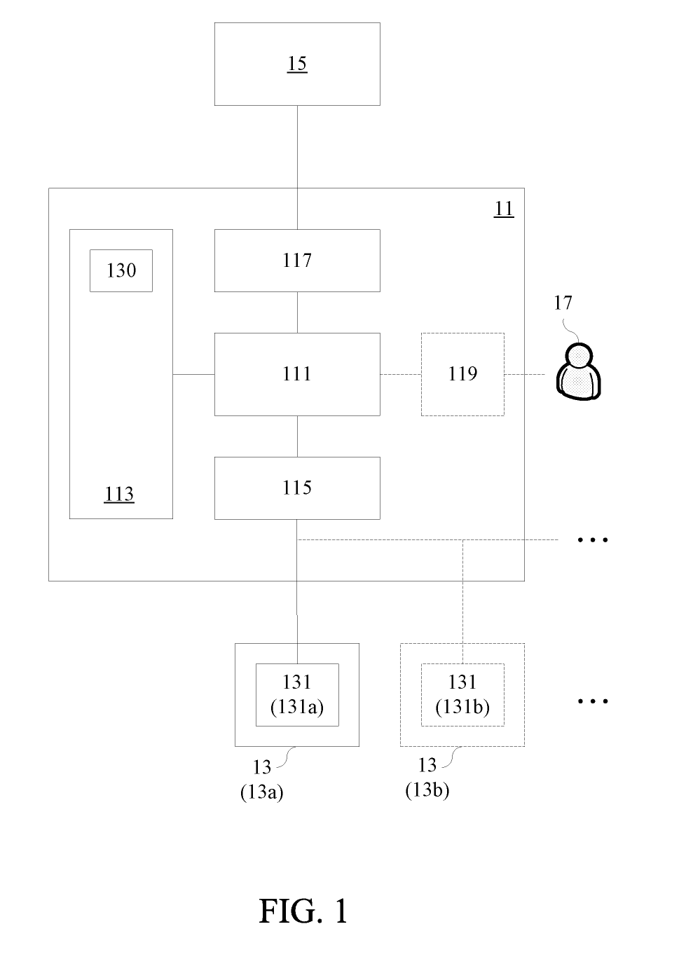

FIG. 1 illustrates an architecture of a gateway connected with one or more original networked machines, in one or more embodiments of the present invention. The content of FIG. 1 is not a limitation to the present invention and its only purpose is illustrating embodiments of the present invention. Referring to FIG. 1, a gateway 11 may comprise a processor 111, a storage 113, a first connection interface 115, and a second connection interface 117, and the processor 111 may electrically connect to the first connection interface 115, the second connection interface 117 and the storage 113. The processor 111 may connect to the first connection interface 115, the second connection interface 117 and the storage 113 directly (i.e., connected not via other elements with specific functions) or indirectly (i.e., connected via other elements with specific functions).

The processor 111 may be any of various microprocessors or microcontrollers capable of signal processing. The microprocessor or the microcontroller is a kind of programmable specific integrated circuit that is capable of operating, storing, outputting/inputting or the like. Moreover, the microprocessor or the microcontroller can receive and process various coded instructions, thereby performing various logical operations and arithmetical operations and outputting corresponding operation results.

The storage 113 may have various storage units comprised in general computing devices/computers. The storage 113 may comprise a primary memory (also called a main memory or an internal memory) which is called a memory for short, and the memory directly connects to the processor 111. The processor 111 can read instruction sets stored in the memory and execute these instruction sets if needed. The storage 113 may further comprise a secondary memory (also called an external memory or an auxiliary memory), and the secondary memory connects to the central processor via I/O channels of the memory instead of directly connecting to the central processor and uses a data buffer to transmit data to the primary memory. The data in the secondary memory does not disappear even in the case without power supply (i.e., is non-volatile). The secondary memory may for example be any of various hard disks, optical disks or the like. The storage 113 may also comprise a third-level storage device, i.e., a storage device that can be inserted into or pulled out from a computer directly, e.g., a mobile disk.

The first connection interface 115 may be configured to connect with one or more original networked machines 13, and communicate with PLCs 131 configured on the one or more original networked machine 13 respectively according to an original communication protocol of each of the original networked machines 13. Through the first connection interface 115, the processor 111 may transmit instructions to the PLC 131 configured on each original networked machine 13, and may also receive data from the PLC 131 configured on each original networked machine 13. The first connection interface 115 may comprise an Ethernet communication interface and/or a Serial communication interface. If the first connection interface 115 comprises the Ethernet communication interface, then the original communication protocol of the original networked machine 13 may be for example (but not limited to): Melsec FX-3U (1E), Q-Ethernet-binary(3E), Q/L-Ethernet-ASKII(3E), CS/CJ FINS/TCP, Profibus, S7-300, ModbusTCP or the like. If the first connection interface 115 comprises the Serial communication interface, then the original communication protocol of the original networked machine 13 may be for example (but not limited to): A type, FX type, Q type, CS/CJ Series Host Link, CS/CJ Series FINS or the like.

In some embodiments, the first communication interface 115 may communicate with the original networked machine 13 asynchronously. Specifically, during the communication between the first connection interface 115 and the original networked machine 13, the processor 111 may transmit a read instruction/write instruction to the original networked machine 13, and wait to transmit another read instruction/write instruction to the original networked machine 13 until a message indicating that the original networked machine 13 has finished the execution of the read instruction/write instruction is transmitted to the processor 111 from the original networked machine 13. Such an asynchronous communication mode features a complicated implementation, a hard debugging operation, a high efficiency, a low utilization ratio of the processor or the like.

In some embodiments, the first communication interface 115 may communicate with the original networked machine 13 synchronously. Specifically, during the communication between the first connection interface 115 and the original networked machine 13, the processor 111 may transmit a read instruction/write instruction to the original networked machine 13, and inquire whether the original networked machine 13 has finished the execution of the read instruction/write instruction at a predetermined cycle (e.g., every 0.3 seconds) and transmit another read instruction/write instruction to the original networked machine 13 after it is determined that the original networked machine 13 have finished the execution of the read instruction/write instruction. Such a synchronous communication mode features a simple implementation, an easy debugging operation, a low efficiency, a high utilization ratio of the processor or the like.

The second connection interface 117 may comprise various communication interfaces to connect with one or more servers 15, and the communication interface may for example be an Ethernet communication interface, an Internet communication interface or the like, but not limited thereto. Through the second connection interface 117, the processor 111 may transmit data from the PLC 131 of each original networked machine 13 to the server 15, and may also receive various instructions from the server 15.

In some embodiments, the processor 111 may set a unified communication protocol, and the second connection interface 117 communicates with the server 15 according to the unified communication protocol. In the case where the first connection interface 115 only connects to a single original networked machine 13 (e.g., the original networked machine 13a), the processor 111 may convert the original communication protocol of the original networked machine 13 into the unified communication protocol, and transmit the data received from the PLC 131 configured on the original networked machine 13 to the server 15 according to the unified communication protocol. In the case where the first connection interface 15 connects to a plurality of original networked machines 13, the processor 111 may convert a plurality of original communication protocols of the original networked machines 13 respectively into a unified communication protocol, and then transmit the data received from the PLCs 131 configured on the original networked machines 13 to the server 15 according to the unified communication protocol.

In the case where the first connection interface 15 connects to a plurality of original networked machines 13, all or some of the original communication protocols of the original networked machines 13 may be different from each other. In some embodiments, the processor 111 may comprise a communication protocol agency for converting a plurality of different original communication protocols of the original networked machines 13 respectively into the unified communication protocol. In some embodiments, the processor 111 may comprise a plurality of communication protocol agencies for converting a plurality of different original communication protocols of the original networked machines 13 respectively into the unified communication protocol.

The PLC 131 configured on the original networked machine 13 may be an electronic device consisting of a central processor, a memory, an input/output unit, a power supply module, a digital analog unit or the like, and may be configured to receive (input) and transmit (output) various types of electrical or electronic signals and control or monitor various mechanical and electrical systems. The PLC 131 may comprise a plurality of original channels, and each of the original channels may be an input channel, an output channel or an input/output channel. The input channel may be configured to receive data/instructions from the outside, the output channel may be configured to transmit data/information to the outside, and the input/output channel may be configured to receive data/instructions from the outside and transmit data/information to the outside.

The first connection interface 115 may communicate with each of the original networked machines 13 via the PLC 131 configured on the original networked machine 13, and through the first connection interface 115, the processor 111 may acquire original channel information 130 of the PLC 131 configured on each original networked machine 13, store the original channel information 130 into the storage 113, and update the original channel information 130 stored in the storage 113 periodically or aperiodically. The original channel information 130 of the PLC 131 configured on each original networked machine 13 may include but not limited to the following contents: Channel ID, Name, Channel location, Channel quantity, As-Type (which may include uint16, uint32, uint64, int16, int32, int64, float32, float64 or the like), Multiplier or the like.

In some embodiments, the gateway 11 may further comprise a human-machine interface (HMI) 119 electrically connects to the processor 111. The HMI 119 may comprise various software systems and various input/output elements so that a user 17 can interact with the gateway 11. For example, the HMI 119 may provide an operation interface to be operated by the user 17, and achieve interaction between the user 17 and the gateway 11 via input/output elements which include but not limited to a mouse, a trace ball, a touch pad, a keyboard, a scanner, a microphone, a screen, a touch screen, a projector or the like.

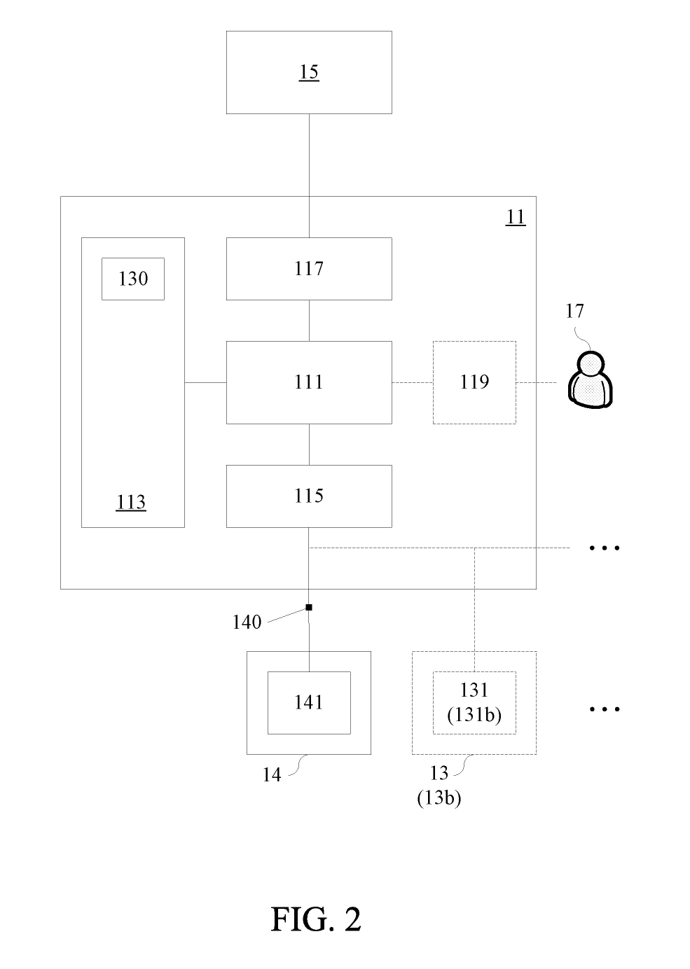

FIG. 2 illustrates the gateway 11 shown in FIG. 1 that is connected with a target networked machine 14 for replacing the original networked machine 13a. As shown in FIG. 2, the gateway 11 is not connected to the original networked machine 13a when the gateway 11 is connected to the target networked machine 14. However, in some embodiments, the gateway 11 may still be connected to the original networked machine 13a when the gateway 11 is connected to the target networked machine 14. The content of FIG. 2 is not a limitation to the present invention and its only purpose is illustrating embodiments of the present invention.

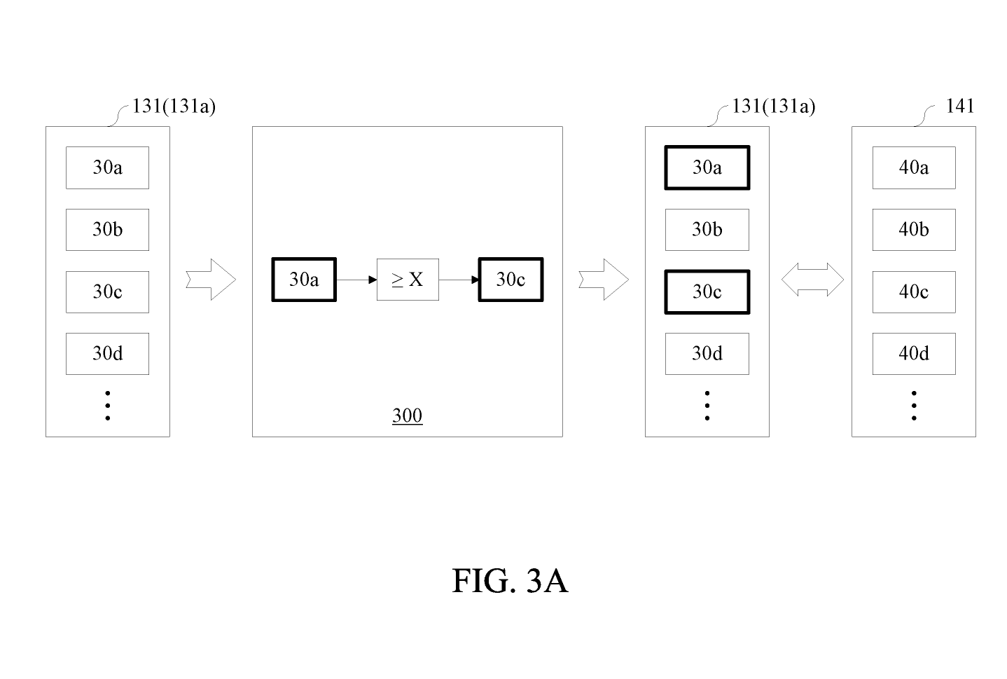

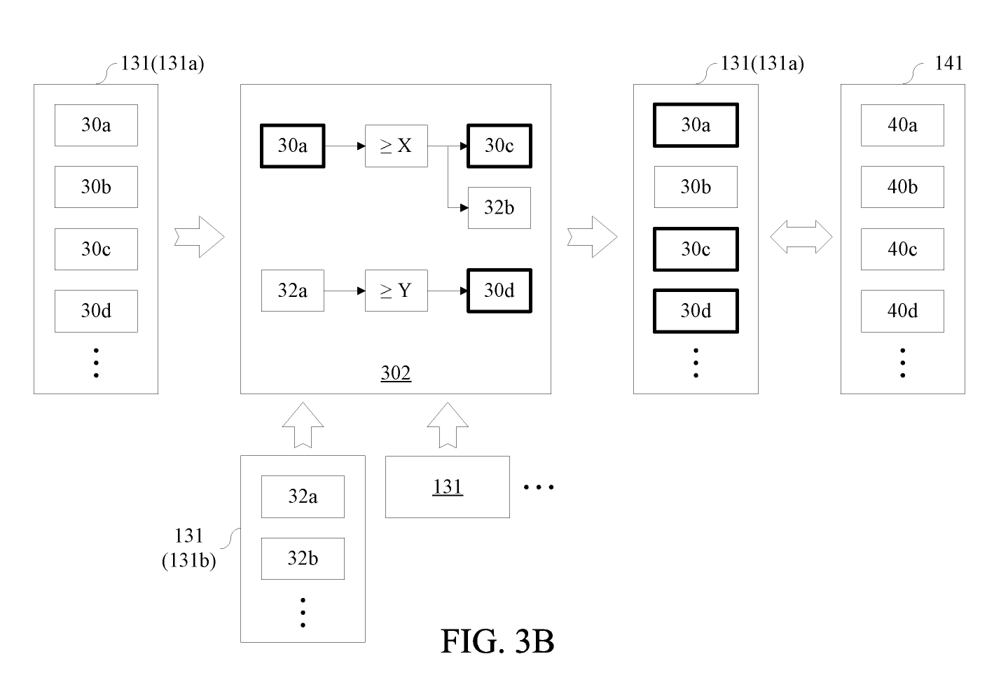

FIG. 3A illustrates how the gateway 11 determines whether the target networked machine 14 is capable of replacing the original networked machine 13a in one or more embodiments of the present invention, where a controlling logic process 300 is defined by the gateway 11 only associated with a single original networked machine 13a. FIG. 3B illustrates how the gateway 11 determines whether the target networked machine 14 is capable of replacing the original networked machine 13a in one or more embodiments of the present invention, where a controlling logic process 302 is defined by the gateway 11 associated with a plurality of original networked machines 13. The content of any of FIGS. 3A-3B is not a limitation to the present invention and its only purpose is illustrating embodiments of the present invention.

First, please refer to FIG. 1, FIG. 2 and FIG. 3A. In the case where the storage 113 stores the original channel information 130 of a single original networked machine 13a therein, the processor 111 may define a controlling logic process 300 based on the original channel information 130 of the original networked machine 13a, and optionally store the controlling logic process 300 into the storage 113. Additionally, the processor 111 may select at least one functional channel from a plurality of original channels of the PLC 131a configured on the original networked machine 13a according to the controlling logic process 300.

The processor 111 may automatically define the controlling logic process 300 according to a default rule built in the gateway 11, and may also define the controlling logic process 300 according to external user instructions. For example, in the case where the gateway 11 comprises the HMI 119, the processor 111 may receive a user instruction from the user 17 via the HMI 119, and then define the controlling logic process 300 based on the original channel information 130 of the original networked machine 13a and according to the user instruction. In some embodiments, the HMI may comprise a Graphical User Interface (GUI), and the GUI may provide the user 17 with a visualized operation system. For example, in this visualized operation system, the user 17 may establish one or more control logics in a specific window by dragging objects. Each of the control logics may comprise at least one of original channels 30a, 30b, 30c, 30d . . . or the like (e.g., represented as a data block), a logical judgment formula (e.g., represented as a judgment block), and a connection line for representing relationships between a selected original channel and the logical judgment formula.

Depending on different requirements, the controlling logic process 300 may comprise one or more control logics, and each of the control logics is correlated with at least one of the original channels 30a, 30b, 30c, 30d . . . or the like comprised in the PLC 131a so that the processor 111 controls the corresponding channel in the original channels 30a, 30b, 30c, 30d . . . or the like comprised in the PLC 131a. Taking FIG. 3A as an example, one control logic comprised in the controlling logic process 300 is “Writing a control instruction to the original channel 30c if the value read from the original channel 30a is greater than or equal to a preset value X”.

For example, it is assumed that the original networked machine 13a is a border loader for manufacturing a Printed circuit board (PCB), wherein the original channel 30a is a temperature sensing channel, the original channel 30c is a border-loading controlling channel, and the preset value X may be a temperature threshold of the original networked machine 13a. In this example, when the temperature value obtained from the temperature sensing channel (i.e., the original channel 30a) by the processor 111 is greater than or equal to the temperature threshold (i.e., the preset value X), the processor 111 may command the border-loading controlling channel (i.e., the original channel 30c) to stop the border-loading operation according to the controlling logic process 300. In this example, only the original channel 30a and the original channel 30c are associated with the controlling logic process 300, so the processor 111 may select the original channel 30a and the original channel 30c from the original channels 30a, 30b, 30c, 30d . . . or the like of the PLC 131a configured on the original networked machine 13a as the functional channels. The exemplary example described herein is only for the purpose of illustrating the embodiments of the present invention instead of limiting the present invention.

In the case where the processor 111 has selected at least one functional channel (e.g., the original channels 30a and 30c in the aforesaid exemplary example) from the plurality of original channels of the PLC 131 configured on the original networked machine 13a according to the controlling logic process 300, the processor 111 can determine whether the target networked machine 14 is capable of replacing the original networked machine 13a by comparing target channel information 140 of a PLC 141 configured on the target networked machine 14 with channel information of the at least one functional channel when the target networked machine 14 connects to the first connection interface 115.

For example, if the processor 111 has selected the original channels 30a and 30c as the functional channels, then the processor 111 can determine whether the target networked machine 14 is capable of replacing the original networked machine 13a simply by comparing the target channel information 140 of target channels 40a, 40b, 40c, 40d . . . or the like of the PLC 141 configured on the target networked machine 14 with the channel information of the original channels 30a and 30c without comparing the target channel information 140 with the original channel information 130 (i.e., channel information of the original channels 30a, 30b, 30c, 30d . . . or the like). Like the original channel information 130, the target channel information 140 may include but not limited to the following contents: Channel ID, Name, Channel location, Channel quantity, As-Type, Multiplier or the like.

If the target channels 40a, 40b, 40c, 40d . . . or the like include a channel of the same type as the at least one functional channel (e.g., the original channels 30a and 30c in the above exemplary example) selected by the processor 111 (i.e., a channel capable of providing the same type of data, or a channel having the same control function), then the processor 111 can determine that the target networked machine 14 is capable of replacing the original networked machine 13a. For example, it is assumed that the original networked machine 13a is a border loader for manufacturing a PCB, the original channel 30a is a temperature sensing channel and the original channel 30c is a border-loading controlling channel In this case, if the function of the target channel 40a is also sensing the temperature value of the target networked machine 14, and the function of the target channel 40c is also controlling the border-loading of the target networked machine 14, then the processor 111 can determine that the target networked machine 14 is capable of replacing the original networked machine 13a.

In some embodiments, the processor 111 can replace the original networked machine 13a with the target networked machine 14 without changing the data transmission format. For example, if the original channels 30a, 30b, 30c, 30d . . . or the like originally correspond to a first data field, a second data field, a third data field, a fourth data field . . . or the like respectively of a certain data transmission format, then after the original networked machine 13a is replaced by the target networked machine 14, the target channels 40a, 40b, 40c, 40d . . . or the like may respectively correspond to the first data field, the second data field, the third data field, the fourth data field . . . or the like of the data transmission format. If so, the transmission mechanism without changing the data transmission format can be more efficient as compared to redefining the data transmission format of a target networked machine 14 each time the original networked machine 13a is replaced by the target networked machine 14.

If the processor 111 determines that the target networked machine 14 is incapable of replacing the original networked machine 13a, then the processor 111 may provide the user 17 with alerting information to inform the user 17 of the reason why the target networked machine 14 is incapable of replacing the original networked machine 13a. For example, if the original channels 30a and 30c are selected as the functional channels by the processor 111, and no one in the target channels 40a, 40b, 40c, 40d . . . or the like is of the same type as the original channel 30a, then the processor 111 may inform the user 17 of the difference between the target networked machine 14 and the original networked machine 13a via the alerting information (e.g., the processor 111 may indicate that no one in the target channels 40a, 40b, 40c, 40d . . . or the like is of the same type as the original channel 30a).

Next, please refer to FIG. 1, FIG. 2 and FIG. 3B. In the case where the storage 113 stores the original channel information 130 of a plurality of original networked machines 13 therein, the processor 111 may define a controlling logic process 302 based on the original channel information 130 of the original networked machines 13, and optionally store the controlling logic process 302 into the storage 113. Additionally, the processor 111 may respectively select at least one functional channel from a plurality of original channels of the PLC 131 configured on each of the original networked machines 13 according to the controlling logic process 302.

Similar to the aforesaid manner in which the processor 111 defines the controlling logic process 300, the processor 111 may automatically define the controlling logic process 302 according to a default rule built in the gateway 11, and may also define the controlling logic process 302 according to external user instructions. How the processor 111 defines the controlling logic process 302 shall be readily appreciated based on the above disclosure of defining the controlling logic process 300 by the processor 111, and thus relevant contents thereof will not be further described herein.

Like the controlling logic process 300, the controlling logic process 302 may comprise one or more control logics depending on different requirements, and each of the control logics is correlated with at least one of the original channels comprised in the PLCs 131 so that the processor 111 controls the corresponding channel in the original channels comprised in the PLCs 131. Taking FIG. 3B as an example, two control logics comprised in the controlling logic process 302 are respectively “Writing a control instruction to the original channel 30c of the PLC 131a and writing a control instruction to an original channel 32b of a PLC 131b if the value read from the original channel 30a of the PLC 131a is greater than or equal to a preset value X” and “Writing a control instruction to the original channel 30d of the PLC 131a if the value read from an original channel 32a of the PLC 131b is greater than or equal to a preset value Y”.

For example, it is assumed that the original networked machine 13a is a border loader for manufacturing the PCB and the original networked machine 13b is an exposure machine for manufacturing the PCB, wherein the original channels 30a, 30c and 30d of the original networked machine 13a are respectively a temperature sensing channel, a border-loading controlling channel and an alerting channel, the original channels 32a and 32b of the original networked machine 13b are respectively an operation time monitoring channel and an exposure controlling channel, the preset value X is a temperature threshold of the original networked machine 13a, and the preset value Y is an operation time threshold of the original networked machine 13b. In this example, when the temperature value obtained from the temperature sensing channel (i.e., the original channel 30a) by the processor 111 is greater than or equal to the temperature threshold (i.e., the preset value X), the processor 111 may command the border-loading controlling channel (i.e., the original channel 30c) to stop the border-loading operation and command the exposure controlling channel (i.e., the original channel 32b) to stop the exposure operation according to the controlling logic process 300. Additionally, in this example, the processor 111 commands the alerting channel (i.e., the original channel 30d) to issue alerting information if the operation time value obtained by the processor 111 from the operation time monitoring channel (i.e., the original channel 32a) is greater than or equal to the operation time threshold (i.e., the preset value Y).

In this example, for the original networked machine 13a, only the original channels 30a, 30c and 30d thereof are associated with the controlling logic process 300, so the processor 111 may select the original channels 30a, 30c and 30d from the original channels 30a, 30b, 30c, 30d . . . or the like of the PLC 131a configured on the original networked machine 13a as the functional channels. The exemplary example described herein is only for the purpose of illustrating the embodiments of the present invention instead of limiting the present invention. In other embodiments, for any of other original networked machines 13, the processor 111 may also select the corresponding functional channels from the plurality of original channels comprised in the PLC 131 thereof according to the controlling logic process 302 (e.g., select the original channels 32a and 32b from the plurality of original channels 32a, 32b . . . or the like of the PLC 131b configured on the original networked machine 13b as the functional channels).

In the case where the processor 111 has selected at least one functional channel (e.g., the original channels 30a, 30b and 30c in the aforesaid exemplary example) from the plurality of original channels of the PLC 131 configured on the original networked machine 13a according to the controlling logic process 302, the processor 111 can determine whether the target networked machine 14 is capable of replacing the original networked machine 13a by comparing target channel information 140 of a PLC 141 configured on the target networked machine 14 with channel information of the at least one functional channel when the target networked machine 14 for replacing the original networked machine 13a connects to the first connection interface 115. How the processor 111 determines whether the target networked machine 14 is capable of replacing the original networked machine 13a and the corresponding actions after determining whether the target networked machine 14 is capable of replacing the original networked machine 13a have been described clearly in the above descriptions, and thus will not be further described herein.

During the process of determining whether the target networked machine 14 is capable of replacing the original networked machine 13a, the processor 111 will not make alternation either for the controlling logic process 300 of the PLC 131a configured on a single original networked machine 13a or for the controlling logic process 302 of the PLCs 131 (e.g., the PLC 131a and the PLC 131b) configured on the original networked machines 13, so it can be ensured that the controlling logic process previously defined by the gateway 11 will not be changed by replacing the original networked machine 13a with the target networked machine 14. To put it another way, in this case, the server level, the gateway level and the networked machine level can still maintain the previous normal operation without influencing the operation and the setting of other original networked machines 13 after the original networked machine 13a is replaced by the target networked machine 14.

In some embodiments, in the case where the first connection interface 115 connects with a plurality of original networked machines 13, the first connection interface 115 may communicate with each of the plurality of original networked machines 13 asynchronously or synchronously as described above.

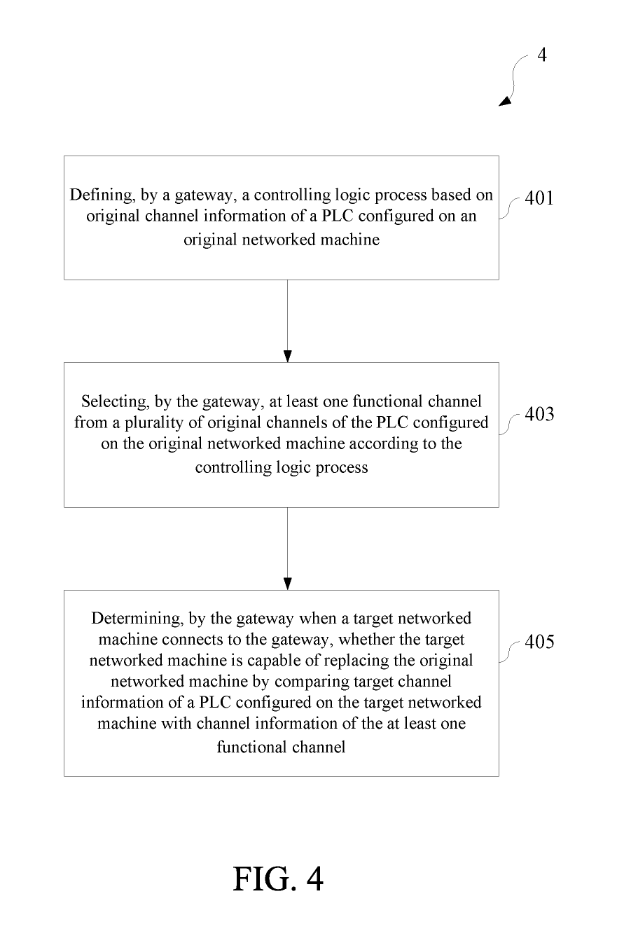

FIG. 4 illustrates a method of determining machines to be networked at a gateway in one or more embodiments of the present invention. The content of FIG. 4 is only for purpose of illustrating embodiments of the present invention instead of limiting the present invention. Referring to FIG. 4, a method 4 of determining machines to be networked may comprise the following steps of:

defining, by a gateway, a controlling logic process based on original channel information of a PLC configured on an original networked machine (labeled as 401);

selecting, by the gateway, at least one functional channel from a plurality of original channels of the PLC configured on the original networked machine according to the controlling logic process (labeled as 403); and

determining, by the gateway when a target networked machine connects to the gateway, whether the target networked machine is capable of replacing the original networked machine by comparing target channel information of a PLC configured on the target networked machine with channel information of the at least one functional channel (labeled as 405).

In some embodiments, for the method 4 of determining machines to be networked, the gateway may store in advance the original channel information of the PLC configured on the original networked machine. In some embodiments, the gateway may acquire the original channel information from a user.

In some embodiments, the method 4 of determining machines to be networked may further comprise the following steps of: communicating, by the gateway, with the original networked machine according to an original communication protocol of the original networked machine; converting, by the gateway, the original communication protocol into a unified communication protocol; and communicating, by the gateway, with a server according to the unified communication protocol.

In some embodiments, for the method 4 of determining machines to be networked, the step of defining the controlling logic process may be as follows: defining, by the gateway, the controlling logic process based on original channel information of a plurality of PLCs configured on a plurality of original networked machines. In those embodiments, the method 4 of determining machines to be networked may further comprise the following steps of: communicating, by the gateway, with the plurality of original networked machines according to a plurality of original communication protocols of the plurality of original networked machines respectively; converting, by the gateway, the plurality of original communication protocols into a unified communication protocol; and communicating, by the gateway, with a server according to the unified communication protocol.

In some embodiments, for the method 4 of determining machines to be networked, the gateway may communicate with the original networked machine asynchronously.

In some embodiments, the method 4 of determining machines to be networked may further comprise the following step of: providing, by the gateway, alerting information if the gateway determines that the target networked machine is incapable of replacing the original networked machine.

In some embodiments, the method 4 of determining machines to be networked may further comprise the following step of: receiving a user instruction and defining the controlling logic process based on the original channel information of the original networked machine and according to the user instruction by the gateway.

In some embodiments, the method 4 of determining machines to be networked may be implemented on the gateway 1. All corresponding steps comprised in the method 4 of determining machines to be networked can be clearly appreciated by a person having ordinary skill in the art based on the above description of the gateway 1, and thus will not be further described herein.

In the embodiments of the present invention, when a gateway connects to one or more original networked machines, the gateway may define a controlling logic process based on the original channel information of the one or more original networked machines, and select at least one functional channel (i.e., one or more functional channels) from a plurality of original channels of the PLC configured on the original networked machine or select at least one functional channel from a plurality of original channels of a plurality of PLCs configured on the original networked machines according to the controlling logic process. The gateway may control the one or more original networked machines according to the controlling logic process. The controlling logic process may comprise one or more control logics, and each of the control logics is at least associated with one channel of the PLC of one of the one or more original networked machines. When a target networked machine for replacing one of the one or more original networked machines connects to the gateway, the gateway may determine whether the target networked machine is capable of replacing the original networked machine by comparing target channel information of a PLC configured on the target networked machine with channel information of the at least one functional channel.

When comparing the target channel information of the PLC configured on the target networked machine with the channel information of the at least one functional channel, it can be ensured that the controlling logic process previously defined by the gateway will not be changed by replacing one of the one or more original networked machines with the target networked machine as long as the PLC on the target networked machine has a target channel of the same type as the at least one functional channel (i.e., a channel capable of providing the same type of data, or a channel having the same control function). To put it another way, in this case, the server level, the gateway level and the networked machine level can still maintain the previous normal operation without influencing the operation and the setting of other original networked machines after one of the one or more original networked machines is replaced by the target networked machine. Therefore, the gateway in the embodiment of the present invention can determine whether the target networked machine is capable of replacing one of the one or more original networked machines simply by comparing the target channel information of the PLC configured on the target networked machine with the channel information of the at least one functional channel, while ensuring that the server level, the gateway level and the networked machine level can maintain the previous normal operation. In other words, the gateway in the embodiment of the present invention does not need to compare information of all channels of the PLC configured on a target networked machine with information of all channels of the PLC configured on an original networked machine one by one in order to determine whether the target networked machine is capable of replacing the original networked machine, thereby improving the efficiency.

On the other hand, after replacing the original networked machine with the target networked machine, the gateway in the embodiment of the present invention does not need to re-define a controlling logic process to maintain the operation of the server level, the gateway level and the networked machine level, so the gateway is more efficient as compared to the conventional gateway. This benefit is more obvious particularly in a case where the previously defined controlling logic process covers a plurality of PLCs configured on a plurality of original networked machines and the plurality of original networked machines have different communication protocols.

According to the above descriptions, a more efficient determining mechanism for determining whether the target networked machine is capable of replacing the original networked machine is provided by the embodiments of the present invention, while ensuring that the server level, the gateway level and the networked machine level in the IIOT can maintain the previous normal operation.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A gateway, comprising:
a first connection interface;
a storage, being configured to store original channel information of a programmable logic controller (PLC) configured on an original networked machine; and
a processor electrically connected to the first connection interface and the storage, being configured to:
define a controlling logic process based on the original channel information of the original networked machine; and
select at least one functional channel from a plurality of original channels of the PLC configured on the original networked machine according to the controlling logic process;
wherein when a target networked machine connects to the first connection interface, the processor determines whether the target networked machine is capable of replacing the original networked machine by comparing target channel information of a PLC configured on the target networked machine with channel information of the at least one functional channel.

2. The gateway of claim 1, further comprising a second connection interface, wherein the first connection interface communicates with the original networked machine according to an original communication protocol of the original networked machine, the processor converts the original communication protocol into a unified communication protocol, and the second connection interface communicates with a server according to the unified communication protocol.

3. The gateway of claim 1, wherein the storage stores original channel information of a plurality of PLCs configured on a plurality of original networked machines, and the processor defines the controlling logic process based on the original channel information of the plurality of original networked machines.

4. The gateway of claim 3, further comprising a second connection interface, wherein the first connection interface communicates with the plurality of original networked machines according to a plurality of original communication protocols of the plurality of original networked machines respectively, the processor converts the plurality of original communication protocols into a unified communication protocol, and the second connection interface communicates with a server according to the unified communication protocol.

5. The gateway of claim 1, wherein the first connection interface communicates with the original networked machine asynchronously.

6. The gateway of claim 1, wherein the processor provides alerting information if the processor determines that the target networked machine is incapable of replacing the original networked machine.

7. The gateway of claim 1, further comprising a human-machine interface (HMI), wherein the HMI is configured to receive a user instruction, and the processor defines the controlling logic process based on the original channel information of the original networked machine and according to the user instruction.

8. The gateway of claim 7, wherein the HMI comprises a graphical user interface (GUI).

9. A method of determining machines to be networked at a gateway, comprising:
defining, by the gateway, a controlling logic process based on original channel information of a PLC configured on an original networked machine;
selecting, by the gateway, at least one functional channel from a plurality of original channels of the PLC configured on the original networked machine according to the controlling logic process;
determining, by the gateway when a target networked machine connects to the gateway, whether the target networked machine is capable of replacing the original networked machine by comparing target channel information of a PLC configured on the target networked machine with channel information of the at least one functional channel.

10. The method of claim 9, further comprising:
communicating, by the gateway, with the original networked machine according to an original communication protocol of the original networked machine;
converting, by the gateway, the original communication protocol into a unified communication protocol; and
communicating, by the gateway, with a server according to the unified communication protocol.

11. The method of claim 9, wherein the step of defining the controlling logic process is as follows: defining, by the gateway, the controlling logic process based on original channel information of a plurality of PLCs configured on a plurality of original networked machines.

12. The method of claim 11, further comprising:
communicating, by the gateway, with the plurality of original networked machines according to a plurality of original communication protocols of the plurality of original networked machines respectively;
converting, by the gateway, the plurality of original communication protocols into a unified communication protocol; and
communicating, by the gateway, with a server according to the unified communication protocol.

13. The method of claim 9, wherein the gateway communicates with the original networked machine asynchronously.

14. The method of claim 9, further comprising:
providing, by the gateway, alerting information if the gateway determines that the target networked machine is incapable of replacing the original networked machine.

15. The method of claim 9, further comprising:
receiving a user instruction and defining the controlling logic process based on the original channel information of the original networked machine and according to the user instruction by the gateway.
